(19) United States
(12) Patent Application Publication
(10) Pub. No.: US 2011/0167073 A1
(43) Pub. Date: Jul. 7, 2011

(54) SYSTEM AND METHOD FOR IN-DEPTH ANALYSIS OF LOCATION AND TIME BASED PATTERNS IN CELLULAR NETWORKS

(76) Inventor: Erel ROSENBERG, Shoham (IL)

(21) Appl. No.: 12/983,333

(22) Filed: Jan. 3, 2011

Related U.S. Application Data
(60) Provisional application No. 61/291,979, filed on Jan. 4, 2010.

(51) Int. Cl. G06F 17/30; H04B 17/00

(52) U.S. Cl. 707/752; 707/754; 707/812; 455/67.11; 707/E17.044

(57) ABSTRACT

A system and method for in-depth analysis of location and time based patterns in cellular networks is provided. A processor processes data received from tracking the movements of a target over a period of time. The data is filtered into recurring time patterns and an event vector comprising an ordered sequence of events from the received data is created. Routines for static areas of high target activity and routines for routes of high target activity are then created.

### FIELD OF THE INVENTION

The present invention relates to a system and method for in-depth analysis of location and time based patterns in cellular networks.

### BACKGROUND OF THE INVENTION

The present innovation is related to data mining and data clustering technology, more specifically to geospatial data mining where only a small number of measurements is available.

Clustering of small number of geospatial measurements raises two questions: how to cluster the measurement on time, where the time difference between the measurements is varied and how to cluster the measurements on the geographic domain where different measurements can represent different levels of accuracy and different type of location, such as ellipse, cycle, polygon, for example.

Traditional clustering methods that use time a numeric vector do not take into account the correlation between measurements close in time. Furthermore those methods do not take into account the inter correlation between measurements due to the cyclicality of time, such as two measurements taken on Sunday, for example.

On the geographic domain, using location as a two dimension matrix does not take into consideration the different uncertainty that is associated with different measurement type and therefore raise accuracy problems when the location objects varies.

### SUMMARY OF THE INVENTION

The proposed method overcomes limitations of the prior art by using a multi step processing method specifically adapted to location information available by cellular networks, for example.

The system utilizes a Routine Analysis Engine (RAE) that reaches complex conclusions from seemingly unnoticeable patterns within vast amounts of data, such as from an entire cellular network, for example.

Using location data (as opposed to call data), the system uses a unique array of Geospatial Data Mining analysis tools in order to build advanced behavioral analysis models of monitored subjects. It is designed to integrate with back-end cellular monitoring systems or databases. The system provides operators with conclusive intelligence based on identification of specific phenomena, too subtle to be identified by regular means.

“Routines” are the cornerstone of systems' unique behavioral model: the system identifies routine geospatial behaviors of cellular subscribers, and utilizes them as the basis for further analysis.

The system learns activity patterns over time, and evolves with the network; this allows the system to provide insightful conclusions for operators through analysis of large amounts of data. The system may be effectively used both as a passive system, periodically fed with data, or as an on-line system.

Constant subscriber monitoring allows the system to identify suspicious behavior and deviations from expected routine. The system conducts profiling, and constantly refines the subscriber's known routine behavior profiles. Most importantly, the system identifies the relevant time frames for each subscriber's routine; this means that the system adapts to people with unique and unexpected timetables.

There is therefore provided, in accordance with an embodiment of the present invention, a system and method for in-depth analysis of location and time based patterns in cellular networks,

The method includes a processor which processes data received from tracking the movements of a target over a period of time. The data is filtered into recurring time patterns and an event vector comprising an ordered sequence of events from the received data is created. Routines for static areas of high target activity and routines for routes of high target activity are then created.

Furthermore, according to an embodiment of the invention, the event vector is created by sorting the sequence of events chronologically and combining events having similar location and time frames into a single event vector. If an event vector continues past midnight, the event vector may be split into two separate vectors. The time and location of the event sector are then determined.

Furthermore, according to an embodiment of the invention, the step of determining the location of the event sector includes the step of combining a group of locations in the proximity of each other into a single location.

Furthermore, according to an embodiment of the invention, the step of filtering includes the step of creating a list of time patterns. The list of time patterns may include at least one of a group including a daily time pattern calendar that includes events repeated on a daily basis, a weekly time pattern calendar that includes patterns for each day of the week, and a time pattern that includes events recurring for a pre-determined minimum number of times.

Furthermore, according to an embodiment of the invention, the step of creating routines for static areas of high target activity includes the steps of:

determining potential locations of high target activity;

determining routines for each minute of each of the list of time patterns;

building full length static area routine from routine arrays;

merging static area routines having similar activity;

filtering out any static area routine not occurring over a pre-determined minimum number of different days;

assigning strength values to each of the static area routines of high target activity and discarding any static area routine below a pre-determined strength value;

adjusting the time span of the routine to relate to the static area only;

determining the actual location of each static area routine of high target activity;

re-assigning strength values to each static area routine of high target activity;

repeating the step of merging static area routines having similar activity according to the actual location of each routine of high target activity; and

merging static area routines occurring within a pre-determined number of minutes from one another and which share the same time pattern and location, into longer routines.

Furthermore, according to an embodiment of the invention, the step of creating routines for routes of high target activity includes the steps of:

creating a potential route between two consecutive static area routines of high target activity;

determining whether a potential route is compatible with the static area routines occurring before and after it,

merging consecutive route routines which are separated by a pre-determined time gap and which share the same time pattern and location, into longer routines;

filtering out any route routine having a time span less than a predetermined amount;

assigning strength values to each of the route routines of high target activity and discarding any route routine below a pre-determined strength value; and

adjusting the time span of merged routines to match the time of the relevant event.

Furthermore, according to an embodiment of the invention, the step of determining includes the steps of:

for each possible route-calendar combination, creating a time array of 1440 cells, each cell having a strength value denoting the likelihood of activity, assigned to it;

inserting vectors which apply to the list of time patterns into the time array;

incrementing the strength values for the cells of the array which fall between the start time and the end time of the vector by one; and

grouping all consecutive non-empty cells in the time array into a new routine.

The system includes a routine analysis engine, which includes a database for storing data received from tracking the movements of a target over a period of time and a processor configured to create routines for static areas of high target activity and for routes of high target activity from the data received.

Furthermore, according to an embodiment of the invention, the routine analysis engine further includes an event vector unit for ordering the received data into a sequence of events and a filter for filtering the data into recurring time patterns.

Furthermore, according to an embodiment of the invention, the event vector unit includes a sorting unit for sorting the sequence of events chronologically, a combining unit for combining events having similar location and time frames into a single event vector, and a calculator for determining the time and location of an event sector.

### BRIEF DESCRIPTION OF THE DRAWINGS

The present invention will be understood and appreciated more fully from the following description taken in conjunction with the appended drawings in which:

FIG. 1 is a schematic flow chart illustration of the routine analysis engine processing method, in accordance with an embodiment of the present invention; and

FIG. 2 is a schematic flow chart illustration of the method of creating an event vector used in routine analysis engine processing method of FIG. 1.

### DESCRIPTION OF THE INVENTION

This present invention relates to a system and method for in-depth analysis of location and time based patterns in cellular networks. The system is a Routine Analysis Engine (RAE) which can reach complex conclusions from seemingly unnoticeable patterns within vast amounts of data.

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

A “Routine” is defined as a periodically occurring time span at a certain area of interest (AOI) in which the activity of a specific target is substantial.

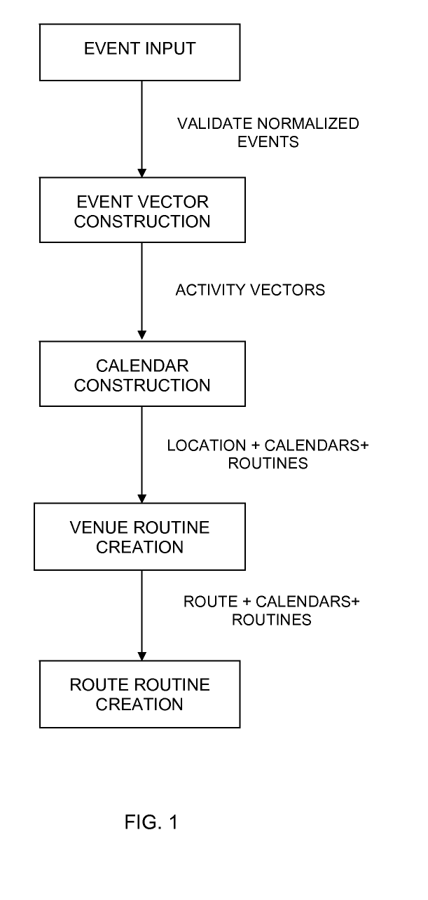

Reference is now made to FIG. 1, which is a schematic flow chart illustration of the routine analysis engine processing method, in accordance with an embodiment of the present invention.

Table 1 summarizes the processing method's stages illustrated in FIG. 1. Target may be tracked over a period of time and the movements recorded. The data received may be used to create venue (static areas) routines and route routines of high target activity.

TABLE 1
Processing Method's Stages

| Stage | | |
|---|---|---|
| N^{o} | Stage Title | Description |
| I | Event Input | This stage receives an event list, containing the |
| | | movements of a target over a period of time. |
| | | The events receive initial processing in order to |
| | | prepare them for use in later steps (see |
| | | table 3 hereinbelow). |
| II | Event Vector | The event list is used to build up a list of |
| | | event vectors Construction (see Table |
| | | 4 hereinbelow). |
| III | Calendar | Up until this point, the target data has been ordered |
| | Creation | geographically. The target data is chronologically. |
| | | A list of calendars is created in order to filter the |
| | | data into different recurring time patterns (See |
| | | Calendar List Creation below). |
| | | All Routine information is relative to its specific |
| | | calendar. |
| IV | Venue | Routines are found for venues of high target |
| | Routine | activity. |
| | Creation | |
| V | Route | Routines are found for routes of high target activity |
| | Routine | |
| | Creation | |

### Data Types

Table 2 lists the data types used in the description of the processing method.

TABLE 2
Data Types

| Data Type | Explanation |
|---|---|
| Location | A geographic area represented by a polygon, ellipse or arc. |
| Event | Consists of a date, time and location of the target, as well as a |
| | containment probability (external) and normalized confidence (added |
| | internally) values which denote the probability of the targets presence in |
| | the location. |
| Event List: | Defined for a specific target over a period of time, This period is referred |
| | to as the Target Observation Period. |
| Event Vector: | An ordered sequence of events containing a start date-time, end date- |
| | time, location and normalized confidence value. |
| AOI—Area Of | Includes a location, a strength value and a List of associated vectors. An |
| Interest | AOI could be either a Venue denoting a static Area of high target activity |
| | or a Route denoting a path of high target activity. |
| Venue | A Venue is a geographic location where target activity is high |
| Calendar | This represents a 24-hour period which occurs repeatedly over the |
| | Target Observation Period. |
| | It can recur according to any combination of the following patterns: |
| | 1) Day/s of the week |
| | 2) Date/s of the month |
| | 3) Relative Dates of the month (e.g. 1^{st} Friday) |
| | 4) Custom dates supplied as inputs |
| | For example: Monday's Calendar records everything that happens |
| | repeatedly on all the Mondays during the Target Observation Period (of |
| | course this is not limited to weekdays). All Schedule information is |
| | relative to its specific Calendar. |
| Routine | Consists of a starting time, ending time, routine-strength-value and |
| | relative Strength value as well as its relevant AOI data and Calendar |
| | Data. |

### Event Pre-Processing

In an embodiment of the invention, several initial tasks may be performed on the input data in order to prepare it for further processing, as shown in Table 3:

TABLE 3
Event Pre-processing

| | |
|---|---|
| Time Zone integration | If local time-zone shift data or DST shift data was included |
| | with the input data then all the date-time values of the input |
| | events are treated as UTC time and then shifted according to |
| | the received time-zone data. |
| | This is important since the user routine's are relative to |
| | morning and evening at the locale of the user. |
| Initial success | The amount of days of target movements which the event list |
| estimate | contains is determined, (hereinafter: Target Observation |
| | Period) |
| | This is used in to determine where a routine is statistically |
| | viable - as described in “Calendar List Creation” |
| | hereinbelow). |
| Excluded Locations | An excluded location list is used where there are a number of |
| | locations in which it is known that no user routine exists. If |
| | this list is received as input then all events in the event list |
| | whose locations intersect with a location from the excluded |
| | location list are removed. |
| Normalized | In order to ascertain the position of the user from the many |
| Containment- | user-locations received as input, these locations are ranked |
| probability | according to there accuracy. The ranking process is non- |
| | trivial since locations differ in size, shape and containment- |
| | probability. |
| | A Normalized-Containment-probability measurement is used |
| | for this ranking: |
| | Normalized containment-probability is defined as the locations |
| | surface area divided by the events containment-probability value. |
| | Therefore, the lower the value, the better the normalized |
| | containment-probability. |
| | If the event does not contain a containment-probability value then a |
| | value of 1 is used. |

### Event Vector Creation

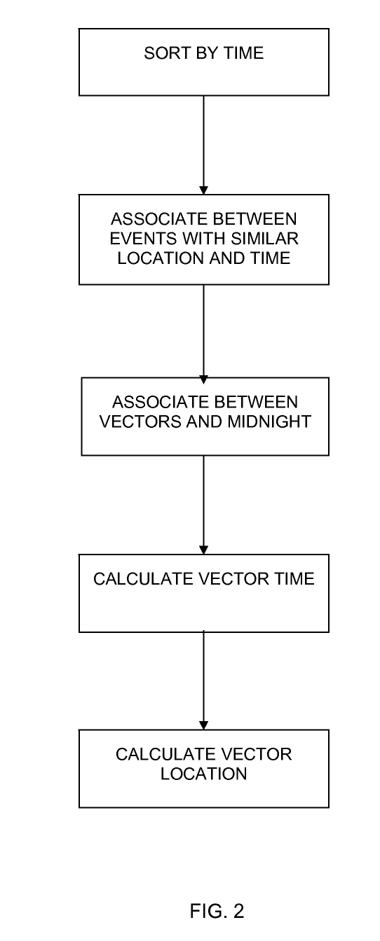

In an embodiment of the invention, the event list is used to build up a list of event vectors, as shown in FIG. 2. The creation of an event vector is described with reference to Table 4.

TABLE 4
Event Vector Creation

| | |
|---|---|
| Step 1 | The event list is ordered chronologically. |
| Step 2 | Vectors are built from sequences of events according to the following criteria: |
| | The events occur consecutively. |
| | The time span from the first event in the sequence to the last event cannot be |
| | longer than a certain maximum time span (see “Algorithm Variables” below). |
| | The location of the first event in the sequence must intersect with the locations |
| | of all successive events in the sequence. |
| Step 3 | Any Event Vector which crosses over midnight into a new day is split into 2 |
| | vectors: One which ends at 23:59:59 and one which begins the next day at |
| | 00:00:00. |
| | This is important since by definition, time patterns recur in the context of a 24 |
| | hour day, Any events occurring after midnight are potentially part of the |
| | morning time pattern. |
| Step 4 | A certain number of minutes may be added onto the beginning and end of |
| | each vector (see “Algorithm Variables” below). |
| Step 5 | The location and normalized containment-probability values for each vector |
| | are taken from the location values of its events according to the steps outlined |
| | in (as described in section “Optimal location finding” below). |

### Calendar List Creation

In an embodiment of the invention, after building a list of event vectors, a “List of Calendars” may be created in order to filter the data into different recurring time patterns. All routine information is relative to its specific calendar. Calendars define the time-patterns in which routine-activity is scanned for. By default the following Calendars may be created:
Davy: Time patterns which repeat themselves every day.
Weekly: A calendar is created for each day of the week.

Additionally, certain calendars may also be received as inputs. These will be used along with the default calendars for detecting routines.

Types of user-input calendars which may be used include:
Custom Calendar: This can be a more complex rime-pattern specifying times relative to a position in the week or month as well as a list of dates.
Non-Working-days: This calendar specifies local weekends holidays and vacations. If a Non-Working-days Calendar is included then a Working-days calendar will also be automatically created from all the remaining days in the target-observation-period.

A custom calendar will only be created if it recurs at least a certain minimum amount of tires (in accordance with the “Algorithm Variables” described below) within the target observation period. Thus, routines are not detectable where the statistical data is too sparse to ensure their accuracy. For example, if 30 days of target event data is provided and the minimum value is 10, then a ‘Mondays’ calendar cannot be created as there are only 4 or 5 Mondays in a 30 day period.

In contrast to this, weekly calendars are still created even if they do not contain the required amount of days since in the routine-merging stage many weekly calendars could be merged to form a routine spanning more days than any of its original calendars.

### Venue Routine Creation

“Venue Routines” are routines which take place at locations of importance to the target.

They may be created through the following stages:
1. Initial venues are created as potential locations where routines could occur;
2. Initial minute long routine arrays are created for each venue-calendar combination.
   Routines may then be searched for in each venue for all the different calendars, as defined hereinabove.
3. Full length routines may be built from the routine arrays, as described by “Routine Creation Sub-Algorithm” below.
4. Similar routines are merged, as described by “Routine merging” below.
5. Routines with sparse sample days may then be filtered
   After routine merging has taken place, any routine whose events are not spread out over a certain minimum of different days according to their calendar (the minimum calendar-size is described in “Algorithm Variables” below) is discarded. This filtering may be performed at this stage in order to give weak routines a chance to merge with other routines instead of being discarded.
6. Routines filtered by strength.
   Routines strength values may be calculated as the number of days in which target activity (events) was recorded in a particular routine divided by the total number of days sampled.
   Any Routine whose strength is less than a certain minimum value (as described by “Algorithm Variables” hereinbelow) is discarded.
   This stage is generally performed only after routine-merging has taken place in order to allow weak routines from a fragmented venue to unite and increase in strength before they are prematurely discarded.
7. Routines shrunk around events
   Owing to vector-time-extrapolation and routine-merging some routine time-spans might extend backwards or forwards beyond the times of a routines first and last events. In these cases, the routines time-span may be shrunk in order to only encompass the times of the events which belong to it.
8. New Venues created
   The initial venues created in stage 1 may be inaccurate owing to noise from random events (for example) since it groups events only by location and not by time. After the initial routines have been created, venues may be found more clearly from the locations of the routines, as described in “Venue Creation” hereinbelow.
9. Routines filtered by relative strengths.
   Relative Strengths may be created for routines as described in Routine Relative Strength Evaluation”. This rates the uniqueness of each routine.
   Any routine whose relative strength is less than a certain minimum value is discarded, as described in “Algorithm Variables” hereinbelow.
10. Routines re-merged
   The merging process (described in “Routine merging” hereinbelow) may now be repeated for the new venues.
11. Final Venue Creation
   The venue creation process described in step 8 is repeated one final tune in order to reflect changes made in steps 9 and 10.
12. Routines Merged Consecutively
   Any routines occurring within a certain number of minutes from one another, as described in “Algorithm Variables” below, which share the same calendar and venue may be merged into longer routines.

### Route Routine Creation

“Route Routines” are routines which take place along paths travelled frequently by the target.

They may be created as follows:
1. Routes are created where potentially routines could occur, as described in “Route Detection Sub-Algorithm” hereinbelow.
2. Initial minute long routine arrays are created per calendar per route.
   Each possible route-calendar combination is checked for compatibility by the steps described in “AOI Time Array Sub-Algorithm hereinbelow. The route-calendar pairs found to be compatible are then processed as described in “Route-Routine Filter Creation” hereinbelow.
3. Full length routines may be built from the routine arrays, as described in the “Routine Creation Sub-Algorithm” hereinbelow.
4. Similar Routines may be merged, as described in “Routine merging” hereinbelow.
5. Routines with sparse sample days may be filtered.
   After routine merging has taken place, any routine whose events are not spread out over a certain minimum of different days according to their calendar, as described with relation to the “min-calendar-size” in the “Algorithm Variables” hereinbelow, may be discarded. This filtering may be performed now in order to give weak routines a chance to merge with other routines instead of being discarded.
6. Routines filtered by strength.
   Routines strength values may be calculated as the number of days in which target activity (events) was recorded in a particular routine divided by the total number of days sampled.
   Any routine whose strength is less than a certain minimum value, as described in “Algorithm Variables” herein below, may be discarded.
   This stage too is performed only after routine-merging in order to allow weak routines from a fragmented venue to unify and increase in strength before they are prematurely discarded.
7. Routines shrunk around events
   Due to vector-time-extrapolation and routine-merging some routines' time-spans might extend backward or forward beyond the times of a routines first and last events. In these cases the routines time-span may be shrunk in order to only encompass the times of the events which belong to it.

The various sub-procedures which may be used in accordance with an embodiment of the invention are now described.

### Sub-Procedures

### Initial Venue Creation

A clustering algorithm is run on the location elements of the Vector List which merges vectors which are geographically close to each other into venues.

A venue is defined as a location in which target activity is high

This may be carried out in two ways:
1. If it is known from external data where the targets venues should be then a specific location filter list can be included with the input data. In this case, venues are only built in areas defined by the list, (as shown in Table 5 below).
2. If no specific location list is included as input, then venues will be detected automatically according to the targets event data (as shown in Table 6 below).

The two scenarios are now described:

TABLE 5
with a Specific Location Filter List

| | |
|---|---|
| Step 1 | A list of venues is created from the specific locations list with |
| | each location in the list serving as a venue's location. |
| Step 2 | For each venue created above - all the vectors in the vector |
| | list are checked to see if there locations intersect with the |
| | venues location. |
| | Any vector whose location does intersect with the venue is |
| | associated with that venue (even if they are also associated with |
| | other venues as well). |

TABLE 6
without a Specific Location Filter List

| | |
|---|---|
| Step 1 | The vector list is ordered from the lowest normalized confidence value |
| | upward. |
| Step 2 | Starting with the first vector in the list and with each successive vector, the |
| | following procedure is repeated: |
| | If the vector does not belong to an existing venue then a new venue is created |
| | containing the vector. The venues location and normalized confidence values |
| | are taken from this vector. |
| | All successive vectors in the list whose locations intersect the new venues |
| | location are associated with the venue (even if they are also associated with |
| | other venues as well). |
| Step 3 | A strength value is calculated for each venue according to the steps outlined |
| | in “Venue Routine Relative Strength Evaluation” below. |
| | The venues are filtered by their strengths. Any venue which either has a |
| | strength value of less than a certain limit (see “Algorithm Variables” below) or |
| | a strength value less than a certain ratio to the total days sampled is dropped. |
| | If at the end of this stage there are more venues than a certain limit (see |
| | “Algorithm Variables” below) then only the best venues above this limit are |
| | taken. |

### AOI Time Array Sub-Algorithm

The following procedure creates a time-arrays for Areas-Of-interest (AOI).

An AOI could be either a venue or a route.

The following steps (Table 7) may be followed for each suitable calendar in the Calendar List.

TABLE 7
AOI Time Array

| | |
|---|---|
| Step 1 | A time array containing 1440 cells (60 * 24 - one for every minute of the |
| | calendar) is constructed for each AOI. Each cell in the array contains a |
| | strength value denoting the likelihood of activity in this minute. |
| Step 2 | All the event vectors for each AOI are now filtered through the calendar. |
| | Those vectors which apply to the calendar are inserted into the AOI's time- |
| | array such that all the strength values for the minutes (cells) of the array which |
| | fall between the start time and the end time of a vector are incremented (by |
| | one). |
| | If the AOI in question is a route-AOI, then an additional Route-Routine filter is |
| | created (as described in “Route-Routine Filler Creation” below) and the event- |
| | vectors must pass this filter as well as the calendar filter before being inserted |
| | in the AOI time-array. |
| Step 3 | The arrays' strength values now resemble graphs with the x-axis representing |
| | minutes of the day and the y-axis representing the total activity over the period |
| | of observation. These values are now normalized by dividing them by the |
| | amount of times the calendar repeats itself over the period of observation. For |
| | example. if the current calendar is ‘Monday’ and the period of observation is 30 days |
| | then this value will be 4 or 5 depending on how many Mondays fell in the 30 day |
| | period. |
| Step 4 | Weak cells are filtered out of the arrays: |
| | Any cell whose strength value is less than certain minimum, as described in |
| | “Algorithm Variables” below. |

### Routine Creation Sub-Algorithm

The list of routines may be created as shown in Table 8, for each AOI time array created in the previous section:

TABLE 8
Routine Creation

| | |
|---|---|
| Step 1 | All consecutive non-empty cells in the time array are grouped into a new |
| | routine such that the routine start time is the index of the first cell and the end |
| | time is the index of the last cell. |
| | The location of the routine may be evaluated from the locations of all of its |
| | vectors according to the steps outlined in “Optimal Location Finding” |
| | described hereinbelow. |
| Step 2 | All consecutive routines which are separated by a time gap less than a |
| | certain value (as described in “Algorithm Variables” below) may be merged |
| | into larger routines which bridge these time gaps and average the smaller |
| | routines values. This is carried out in order to account for small gaps in the |
| | routine where logically the target remained in the routine but not enough data was |
| | given to verify this. |
| Step 3 | Any routine whose time span is less than a certain amount is removed from the |
| | list. (as described in “Algorithm Variables” below) |

### Routine Merging

The situation may arise where input data is sparse, causing routines to overlap or eclipse one another.

In the ‘routine merging’ stage, all the routines are compared to one another and, if appropriate, merged into new routines which better reflect the over-all situation-picture.

Merging may take place on three levels:

1. Same-Calendar Different-AOI Merging

Any two routines that fulfill the following four requirements may be merged:

a. They belong to the same calendar (i.e.: Mondays)

b. They belong to different AOI's

c. Their locations intersect.

d. Their time-spans intersect

The above criteria indicate that the two AOI's of the respective routines are actually different parts of the same AOI which were split up due to obscure input data. Hence the two routines are actually the same routine.

The new routine created from the merging of the two original routines contains the following attributes:
The starting time is taken as the earliest starting time from the two original routines.
The ending time is taken as the latest ending time from the two original routines.
The AOI of the new routine is taken as both of the ACA's of the two routines
The strength is taken as the average of the strengths of the two routines
The relative-strength is taken as the sum of the relative strengths of the two routines. (This is since the relative strength was lowered when the two routines where competing and now that they are unified there are less parallel routines to lower the relative-strength).
All event vectors from both routines which intersect the new routines time-span are added to the new routine
   Routine Filtering after Merging

After this stage of routine merging, weak routines may be filtered out according to their relative-strengths. Any routine whose relative-strength is beneath a certain minimum value (as described in “Algorithm Sub-Procedures” below) is discarded.

This filtering has not been performed until now owing to the possibility that the merging of two similar routines from separate AOI's will raise their relative-strength value.

2. Similar Calendar Merging

Similar Calendar Merging happens in two stages:

I. Weekly Calendar Merging

Any Two Routines that fulfill the following three requirements will be merged:
a) They both contain a weekly calendar (i.e.: routine A on Sundays and routine B on Tuesdays)
b) Their locations intersect
c) Their time-spans intersect

Since the merging process is very similar to the one above in (1), only the differences are described in Table 9:

TABLE 9
Weekly Calendar Merging

| | |
|---|---|
| Step 1 | The time-spans of the two routines may be buffered forward and backward |
| | by a certain percentage (as described in “Algorithm Variables” below). |
| Step 2 | A partition-time may be created at the earliest actual-start-time from the two |
| | routines |
| Step 3 | A partition-time may be created at the latest actual-end-time from the two |
| | routines |
| Step 4 | If the actual start-time of one of the routines occurs before the beginning of |
| | the other routines buffer zone, then a partition-time may be created at the |
| | actual-start-time of the other routine. |
| Step 5 | If the actual end-time of one of the routines occurs after the end of the |
| | other routines buffer zone then a partition-time may be created at the |
| | actual-end-time of the other Routine. |
| Step 6 | New routines may be created in the gaps between all the partition-times |
| | created above as follows: |
| | The start-time and end-time of the new routine are taken from the times of |
| | the partitions. The calendar is taken from any one of the two routines (as |
| | they have the same calendar) |
| | If the time-span between the two partitions intersects both routines then: |
| | The calendars of both the original routines may be included in the new |
| | routine. |
| | The relative-strength may be taken as the average of the relative-strengths |
| | from both original routines. |
| | Else if the time-span between the two partitions intersect only one of the |
| | original routines then: |
| | The calendar may be taken from this original routine |
| | The time-span of the new routine may be constricted to begin at the start- |
| | time of the earliest vector it contains and to end at the end-time of the latest |
| | vector it contains. |
| Step 7 | In the event of the following three criteria: |
| | Three new routines were created |
| | The first and third routines have the same AOI |
| | The time-span of the middle Routine is less than a certain percentage (as |
| | described in “Algorithm Variables” below) of the over-all time-span of the three |
| | Routines. |
| | The third new routine may be discarded and the first routine's end-time is |
| | set to the end-time of the third routine |
| Step 8 | The new routines may replace the original routines |

The routines may be ordered in descending order by the length of their time-spans after every merge such that the pair of routines with the longest time-spans are always the pair that is merged next.

The merging process acts recursively until no merges can be performed. Hence for example: at the end of the process there may be a routine with calendars “Monday, Tuesday, Thursday and Friday.

II. Every-Day to Daily Calendar Transformation

In the event that 7 separate Routines for calendars of Sunday, Monday, Tuesday, Wednesday, Thursday, Friday and Saturday are merged together, the result is a weekly routine which actually should be a daily routine (as it effectively happens everyday).

All routines of this type are now renamed to daily routines and added to the daily routines list.

3. Hierarchical Calendar Merging

All routines may be ordered into a hierarchy according to frequency of their calendars in the following manner:

1. Daily Calendars

2. Custom calendars

3. Weekly Calendars

4. Monthly Calendars

The purpose of this hierarchy is to detect infrequent routines which have been made redundant (or eclipsed) by more frequent ones.

For example: If Routine A at AOI-3 occurs weekly on Mondays and Thursdays between 8:00-10:00 and Routine B at AOI-3 occurs Monthly on the 4^{th} of the month between 8:00-10:00 then a check must be performed whether the 4^{th} of the month in the current target-observation-period occurs on either a Monday or a Thursday. If this is so then Routine Bis made redundant by Routine A.

Redundancy checks are performed for every routine occurring in a higher hierarchical level on all the routines below it.

Since the merging process is very similar to the one described in (2) only the differences are described in Table 10:

TABLE 10
Hierarchical Calendar Merging

| | |
|---|---|
| Step 7 | In the event of the three criteria mentioned in (2): |
| | Only the third new routine is discarded and the first routine's |
| | end-time is set to the end-time of the third routine. |
| Step 8 | The higher routine remains as it is (new routines pertaining |
| | to it are discarded) |
| | The lower original routine may be discarded. |
| | Any new routines whose time-spans intersect only the time-span |
| | of the lower routine are taken instead of the original lower |
| | routine. |

Filtering Routines with Sparse Sample Days

After “Routine Merging” has taken place, any routine whose events are not spread out over a certain minimum of different days (as described with respect to minimum calendar size in “Algorithm Variables” below) may be discarded. This filtering is performed at this stage in order to give weak routines a chance to merge with other routines instead of being discarded.

### Venue Creation

A clustering algorithm may be run on the location elements of the venue routines which merges routines which are geographically close to each other into new venues.

This is described in Table 11:

TABLE 11
Venue Creation

| | |
|---|---|
| Step 1 | The routines may be ordered from the one whose location has the lowest |
| | normalized confidence value upward. |
| Step 2 | Starting with the first routine in the list and with each successive routine, the |
| | following procedure may be repeated: |
| | If the routine does not belong to an existing venue then a new venue may |
| | created containing the routine. The venues location and normalized be |
| | confidence values may be taken from this routine. |
| | All successive routines in the list whose locations intersect the new venues |
| | location and do not already belong to another venue are associated with the venue. |
| Step 3 | A strength value may be calculated for each venue according to the steps |
| | outlined in “Statistical Activity strength per day” hereinbelow. |

### Venue Routine Relative Strength Evaluation

In an embodiment of the invention, routines strengths may be evaluated by measuring the uniqueness of a routine at a certain time and calendar. A routine which is alone at a certain time-span and calendar is considered stronger than two routines which occur during the same time-span and calendar but in different venues since it is irrational that a target will have two different routines at the same time.

This measurement is called the “Routines Relative-Strength”. It may be measured as shown in Table 12.

TABLE 12
Routines Relative-Strength

| | |
|---|---|
| Step 1 | A time-array may be created for each time-span of the |
| | routine with a cell per minute. Each cell is given an |
| | initial value of 1. |
| Step 2 | For each calendar, all the routines which take place during |
| | that calendar may be compared. |
| | If two or more routines sharing a calendar also share cells in |
| | their time arrays then the value of each shared cell may be |
| | divided by the number of routines sharing the cell. |
| Step 3 | The relative-strength for each routine may be given as the |
| | average value of all the cells in its time-array. |

### Route Detection Sub-Algorithm

Every combination of venue pairs containing significant target routines may be scanned separately to check if a route exists between the pair.

A “Significant Routine” is one whose time-span is longer than a certain minimum amount (as described in “Algorithm Variables” below).

The scanning may be performed as follows:

All consecutive sequences of vectors which are enclosed in time by the current pair of venues may be collected provided that these sequences fulfill three requirements:
1. None of their vectors belong to arty other venues with significant routine data
2. They do not cover a time-span longer than a certain maximum length (as described in “Algorithm Variables” below)
3. None of there vectors fail outside an ellipse drawn on the straight is path from the start venue to the end venue (as described in “Algorithm Variables” below; for the dimensions of this ellipse).

If such sequences are found, then a route may be built between the pair of venues, as described in Table 13.

TABLE 13
Route building

| | |
|---|---|
| Step 1 | A clustering algorithm may be run on all their vectors in |
| | order to construct clear route points. The algorithm used is |
| | identical to the “Initial Venue Creation” but with a different |
| | minimum Strength filter value. (as described in |
| | Algorithm Variables” below) |
| Step 2 | A heuristic of the Traveling Salesman algorithm is used to |
| | assign ordered numbers to the Route Points. These numbers |
| | denote the path most likely used to traverse all the Route Points |
| | while traveling from the Start Venue to the end Venue. |

Before a route is filtered via a calendar into its AOI time-array it must also pass through additional filtering in order to ascertain that its potential route-routine is compatible with any venue-routines occurring before and after it at its starting venue and ending venue.

This filter consists of a binary array of 1440 units (1 unit for each unit of the AOI Time-Array). The units are all initialized to 0 while only a unit with the value of 1 activates its AOI Time-Array Unit pair as susceptible for Routine data.

The Filter is then prepared as described in Table 14.

TABLE 14
Route Routine Filter Creation

| | |
|---|---|
| Step 1 | Two Lists may be prepared: |
| | The ending times of routines occurring at the routes start-venue. |
| | The starting times of routines occurring at the routes end-venue. |
| | Times are added to these lists provided that they fulfill two conditions: |
| | Their parent routines time-spans are longer than the min-venue routine- |
| | time-span-suitable-for-route setting (as described in “Algorithm Variables” below) |
| | One of their parent routine calendars is the same as the current calendar |
| | being used to filter the route. |
| Step 2 | Time spans may be created between pairs of ending-times and starting- |
| | times from the two lists created above according to the following rules: |
| | Each ending-time is matched with the starting-time closest (time-wise) to it. |
| | The starting-time in the pair must be at least 1 minute later in time than its ending |
| | pair. |
| Step 3 | The time-spans are converted to minutes of the day (numbers between 0 |
| | and 1440) and all the numbers contained within them set their |
| | corresponding unit number to 1 on the Route Filter array. |

### Optimal Location Finding

In an embodiment of the invention, a group of locations in proximity of each-other must be combined to produce a more general location.

Due to variations in accuracy of different location inputs this procedure is non trivial. The convex hull of all the locations is usually too vague as it includes also the extremely inaccurate locations in the group. Also the smallest location is not always correct as it could lack information held in larger locations. An average location shape cannot be found as most location inputs are not statistical in nature.

Therefore, the system contains four area limit variables which are used to filter the locations (as described in “Algorithm Variables” below).
1. Starting with the smallest limit-variable, all the locations are checked to see if any of their normalized-confidence values are smaller than the limit. If one or more such locations are found then the optimal location is found as the convex hull of these locations.
2. If no locations are beneath the limit, then step 1 is repeated with the 2^{nd} 3^{rd} and 4^{th} limits.
3. If all 4 limits are checked and still no locations are found, then the optimal location is taken as the convex hull of all the locations in the group.
4. The optimal locations containment probability is taken from the location with the highest containment probability from all the locations which participated in its convex hull.

In the event that an optimum location must be found from a group which consists solely of coordinates, then an average center point is found from all the coordinates,

### Statistical Activity Strength Per Day

In an embodiment of the invention, strength values must be obtained for location-bound bodies. These bodies are made up of many different events. The strength value is measured by the amount of days over which the events are spread as opposed to simply the amount of events the body contains. This is due to the fact that routine related data puts more of an emphasis on regularly recurring activity than on isolated high activity.

A problem arises where the locations of events used are not very accurate and they intersect with more than one of the location-bound bodies. In this case the event is owned by all the bodies which intersect it however in reality it only occurred at one specific point. It would not be correct in this case to award an entire unit of daily activity to all its owning bodies in this case. Therefore the strength per day is divided up statistically between the events owners.

The process occurs as follows:
Generally if one or more events belonging to a specific body occur on a certain day then that body receives a target activity value for that day of 1.
if an event has a very large location which intersects two or more separate bodies, then that event will give each of its owning bodies a fraction of activity for the day it falls on. This fraction is equal to 1 divided by the number of bodies who share the event.
In all cases, the maximum value of target-activity for a single day is 1.

A non limiting exemplary list of variables which may be used in the algorithm of the present invention is now described.

### Algorithm Variables

In cases where a strict, normal and relaxed value is given, this reflects three different running modes in which the system can operate. The running mode is a variable received as input for the system.
Min Calendar Sample Size
The minimum amount of times a calendar time pattern occurs within the input data in order for it to be valid.
Min Routine Strength per minute
The minimum strength of an initial routine minute cell (as described in “AO/Time Array Sub-Algorithm”) for that routine to be valid
Min Venue Routine Strength
The minimum strength of a venue routine for that routine to be valid
Min Venue Routine Relative Strength
The minimum relative strength of a venue routine for that routine to be valid
Min Route Routine Strength
The minimum strength of a route routine for that routine to be valid
Min Route Routine Relative Strength
The minimum relative strength of a route routine for that routine to be valid
Min Venue Strength, Min Route Point Strength
The minimum amount of days in which activity occurs in a venue/route-point in order for it to be valid
Venue/Route Point ratio To Total Days Sampled
The minimum ratio of days in which activity occurs in a venue/route-point (compared to the total amount of days sampled) in order for it to be valid
Max Venue/Route-point Amount
The maximum number of venues/route-points to be used in a route. Above this number, only the best are taken.
Time Extrapolation Amount
The amount of time added onto each side of a vector where target activity is assumed. Unit—minutes
Max Bridgeable Time Gap
The maximum amount of minutes of a gap between two routines which can be ‘bridged’ to create one large routine—If the two routines occur in the same AOI and Calendar
Max Route Duration
The maximum amount of time in a route for it to be valid. Unit-seconds
Assumed Point Location Radius
The radius around a point where its location extends (with regard to intersecting rigid locations)
Min Circle Radius
The minimum allowed radius of a circular event location. Radii smaller than this will be enlarged
Optimal Location Normalized-Containment Probability limits
The highest normalized area of a Location in order for it to be used in the optimal location's convex hull. 4 levels are used
Max Vector Time Span
The maximum amount of minutes which a vector can extend before it is broken into smaller vectors
Max Venue/Route-point Peak Finding Distance
The maximum distance between two points in which they will be merged by the peak finding algorithm.
Min Routine Duration
The minimum amount of minutes allowed for a routine.
Geometry Engine
The Type of basic Geometric data used for location calculations.
   Types: jts-JTS library with geodetic wrapper
      j2d-Java Shape2D classes
Polygon Step Size
The amount of points used (per degree) in order to represent a curved location object as a polygon for geometric calculations.
Low Res Step Size
A low resolution polygon of a location which is tried first order to improve performance.
Min Venue Routine Time Span Suitable For Route
The smallest venue routine time-span which can be used as the base for a route or which can cut a potential route.
Route Boundary Ellipse Major Axis Ratio
Concerning the ellipse constructed between the starting and ending points of a route, this setting governs the percentage of the distance between the two points of which the ellipses major axis (constructed from the center point between the two points) will be extended past each point.
Note: Major axis Length=(distance between points)/2+(distance between points)*x−such that x is this setting.
a Route Boundary Ellipse Minor Axis Ratio
Concerning the ellipse constructed between the starting and ending points of a route, this setting governs the ratio of the minor axis in proportion to the major-axis
Location Group Output Method
Decides the format of output locations:
   Types: General: for the convex hull of the object or
   Optimal: For the highest quality location of the object
Routine Per Type Merging
Decides whether Routines of similar typed Calendars will be merged or not
   Types: On/Off
a Routine Hierarchical Merging
Decides Whether Routines will be merged hierarchically or not
   Types: On/Off
Routine Time Extrapolation Proportion
Decides the proportion of the buffering which will be added onto the ends of each Routine's time-span during Routine Merging
Routine Min Time Extrapolation Minutes
The minimum amount of buffering added onto the end of each Routine's time-span during Routine Merging if the proportional value is too small. Unit—minutes
Routine Min Bisection Proportion

The minimum proportion between a large routine time-span and a smaller routine time-span which will cause the smaller routine to cut the larger routine into two pieces during routine merging; in the event where the smaller routine falls during the larger routine.
Max Years in Sample Data
The maximum amount of years which the system can process.
Max Number of Events

The maximum amount of events which the system can process.
Min Venue Strength for Output
The minimum relative strength of a venue for that venue to appear in the analysis results xml.
Min Route Strength for Output
The minimum relative strength of a route for that route to appear in the analysis results xml.

It will be appreciated that though the present invention has been described with reference to cellular networks, it is not limited thereto but may also applies to other systems where geospatial behavior is an integral part of the system.

It will be further appreciated that the present invention is not limited by what has been described hereinabove and that numerous modifications, all of which fall within the scope of the present invention, exist. Rather the scope of the invention is defined by the claims, which follow:

1. A method for in-depth analysis of location and time based patterns in cellular networks, comprising:
using a processor to process data received from tracking the movements of a target over a period of time;
creating routines for static areas of high target activity and creating routines for routes of high target activity from the data received.

2. The method according to claim 1, further comprising:
creating an event vector comprising an ordered sequence of events from the received data; and
filtering the data into recurring time patterns.

3. The method according to claim 2, wherein the step of creating an event vector comprises the steps of:
sorting the sequence of events chronologically;
combining events having similar location and time frames into a single event vector;
if an event vector continues past midnight, splitting the event vector into two separate vectors;
determining the time of the event sector; and
determining the location of the event sector.

4. The method according to claim 3, wherein the step of determining the location of the event sector comprises the step of:
combining a group of locations in the proximity of each other into a single location.

5. The method according to claim 2, wherein the step of filtering comprises the step of:
creating a list of time patterns, said list of time patterns comprising at least one of a group including a daily time pattern calendar comprising events repeated on a daily basis, a weekly time pattern calendar comprising patterns for each day of the week, and a time pattern comprising events recurring for a pre-determined minimum number of times.

6. The method according to claim 5, wherein the step of creating routines for static areas of high target activity comprises the steps of:
determining potential locations of high target activity;
determining routines for each minute of each of said list of time patterns;
building full length static area routine from routine arrays;
merging static area routines having similar activity;
filtering out any static area routine not occurring over a pre-determined minimum number of different days;
assigning strength values to each of the static area routines of high target activity and discarding any static area routine below a pre-determined strength value;
adjusting the time span of the routine to relate to the static area only;
determining the actual location of each static area routine of high target activity;
re-assigning strength values to each static area routine of high target activity;
repeating the step of merging static area routines having similar activity according to the actual location of each routine of high target activity; and
merging static area routines occurring within a pre-determined number of minutes from one another and which share the same time pattern and location, into longer routines.

7. The method according to claim 6, wherein the step of creating routines for routes of high target activity comprises the steps of:
creating a potential route between two consecutive static area routines of high target activity;
determining whether a potential route is compatible with the static area routines occurring before and after it,
merging consecutive route routines which are separated by a pre-determined time gap and which share the same time pattern and location, into longer routines;
filtering out any route routine having a time span less than a predetermined amount;
assigning strength values to each of the route routines of high target activity and discarding any route routine below a pre-determined strength value; and
adjusting the time span of merged routines to match the time of the relevant event.

8. The method according to claim 7, wherein the step of determining comprises the steps of:
for each possible route-calendar combination, creating a tune array of 1440 cells, each cell having a strength value denoting the likelihood of activity, assigned to it;
inserting vectors which apply to the list of time patterns into the time array;
incrementing the strength values for the cells of the array which fall between the start time and the end time of the vector by one; and
grouping all consecutive non-empty cells in the time array into a new routine.

9. A routine analysis engine, comprising:
a database for storing data received from tracking the movements of a target over a period of time; and
a processor configured to create routines for static areas of high target activity and for routes of high target activity from the data received.

10. The routine analysis engine according to claim 9, further comprising:
an event vector unit for ordering the received data into a sequence of events; and
a filter for filtering the data into recurring time patterns.

11. The routine analysis engine according to claim 10, wherein the event vector unit comprises:
a sorting unit for sorting the sequence of events chronologically;
a combining unit for combining events having similar location and time frames into a single event vector; and
a calculator for determining the time and location of an event sector.

12. The routine analysis engine according to claim 10, wherein said time patterns comprise at least one of a group including a daily time pattern calendar comprising events repeated on a daily basis, a weekly time pattern calendar comprising patterns for each day of the week, and a time pattern comprising events recurring for a pre-determined minimum number of times.
